(19) United States
(12) Patent Application Publication
(10) Pub. No.: US 2014/0271420 A1
(43) Pub. Date: Sep. 18, 2014

(54) Method and System for Air Capture of Carbon Dioxide

(71) Applicant: SEQUESTRAPOWER, LTD, BEDFORD (GB)

(72) Inventor: Kevin Alexander Paul Kirchman, Bedford (GB)

(73) Assignee: SEQUESTRAPOWER, LTD, BEDFORD (GB)

(21) Appl. No.: 14/285,548

(22) Filed: May 22, 2014

Related U.S. Application Data
(60) Provisional application No. 61/802,435, filed on Mar. 16, 2013.

(51) Int. Cl. B01D 53/14

(52) U.S. Cl. CPC B01D 53/1475
USPC 423/210; 422/187

(57) ABSTRACT

The present invention provides a novel system and method for collecting CO₂ and H₂O from ambient air, using the power of a blower forcing air or another gas through a Reverse Venturi device (also called a divergent-convergent duct), to decrease the velocity of the air over a carbon capture device, and thereby increase the pressure of the unit, which results in raising of the dew point and the subsequent condensation of water in the air. This reduces the sorbent that is absorbed by the passing air stream, and increases the uptake of water vapor when a sorbent is used that attracts water.

### CROSS-REFERENCE TO RELATED APPLICATIONS

This application claims priority of Provisional Patent Application No. 61/826,036, filed on May 22, 2013, the entire disclosure of which is incorporated by reference herein.

### FIELD OF THE INVENTION

This invention relates to the removal of particles from a gas stream using a sorbent and a sorbent regeneration unit, commonly called air capture or a gas scrubber.

### BACKGROUND OF THE INVENTION

It is well known in the art for more than 60 years that a Venturi device could be used to atomize a liquid in order to catch dust and other particles from a passing gas stream. The Venturi reduces the pressure where the liquid is introduced, while increasing the gas velocity, and this high velocity gas stream shears the liquid particles to form the small droplets, which subsequently trap and thus scrub the gas of the particles. In the present invention, the Venturi is used in a gas scrubber for a novel purpose, using a different configuration of the Venturi technology.

Generally, in ambient air on a clear day, the humidity is less than 100%. Thus at a given temperature, the dew point is often higher than the air temperature. Because the humidity is less than 100%, air passing over a water-based solution will generally evaporate some of the water in the solution. Because in a regenerative capture unit the water-based solution recirculates, water lost through evaporation must be replaced. This can be difficult or expensive, if the capture unit is located at a remote or arid site.

For applications of carbon dioxide gas capture utilizing wind turbines for purposes of power-to-fuel conversion of renewable energy, for instance, presently a water source must be provided, which is problematic if the location does not have a water pipeline nearby. The device can also be used where water is sought to be captured as well as CO₂ from the incoming air stream, such as in outer space, when cleaning air in a space capsule when water vapor must be removed, or when the hydrogen from water is needed to be combined with CO₂ in a Sabatier Reactor to form synthetic natural gas (CH₄) or other synthetic gas or liquid fuels.

### BRIEF SUMMARY OF THE INVENTION

In order to overcome this present problem, the present invention utilizes Venturi technology to increase the pressure on the gas passing over the scrubber area, in order to exceed the dew point of the air, and thus prohibit evaporation, and in some cases precipitate additional water from the water vapor in the passing air.

By using a Reverse Venturi with a smaller opening in an inlet duct expanding to a larger opening, the dew point of the gas can be matched by utilizing an area ratio that produces a required pressure increase.

Thus one object of the present invention is to increase the pressure around an enclosed gas capture device, as per Bernoulli's equation reducing the velocity will increase its pressure, which raises the dew point of the passing gas until it reaches the incoming gas temperature, which thus can produce condensation of water vapor from the gas onto the capture device, as well as saturating the gas so that it does not further evaporate water from sorbents in the gas capture device.

A second object of the present invention is to reduce the velocity of flow over a gas capture device, using a reverse Venturi, so that it captures more of the particles that are desired to be removed.

A third object of the present invention is to collect the sorbent material before it begins evaporating by incorporating a bend in the ducting where the liquid sorbent can accumulate and be removed from the gas passage.

### DETAILED DESCRIPTION OF THE INVENTION

One of the methods of capturing CO₂ used in this emerging industry has been to pump a sorbent liquid down plates (known as contactors) over which a gas stream is passing. The sorbent, such as a hydroxide, absorbs the CO₂ and is then regenerated through one of various methods, such as electrodialysis or thermal regeneration, which has as an output CO₂ in more pure form, and the regenerated sorbent, which is fed back to the contactor chamber for a continuous process.

Air or a flue gas passes over these contactors, which are wetted either by pumping the sorbent over them, or introducing the sorbent in the gas by atomizing it. The invention uses a Reverse Venturi device to raise the pressure of this passing gas stream within the gas capture device chamber where the contactors are located, which results in an elevation of the dew point in the gas stream to at or above the incoming air or gas temperature, thus causing moisture in the air or gas stream to condense out and limiting the evaporation by the gas stream of water in the sorbent.

Fortunately, there is a relatively constant relationship between dew points at a given incoming gas temperature and the pressure within the chamber. This can be understood from FIG. 2, which shows example dew points over a temperature range for two different pressures. These two graph lines are separated by a relatively constant distance, so that once the area of the contactor chamber is engineered to slightly exceed the required pressure increase at its maximum operating temperature and minimum operating humidity, it functions effectively for other ambient temperatures (the distance between the lines increases slightly, but this does not undermine the conclusion). This means the device does not require external control systems in order to function.

In addition, the reverse Venturi device, in the process of raising the pressure, slows the velocity of the air stream, allowing greater uptake of CO₂ by the sorbent, which is time dependent.

The following example illustrates the relationship between the measurable variables in the capture process. In this case, the pressure is chosen of 19 psia because that is the pressure that will produce 100% humidity from the input ambient gas conditions, by raising the dew point of the gas so as to be equal or greater than the incoming temperature:

| Pressure: | 14.7 | psia | [symbol] | 19 | psia (produced after passing |
|---|---|---|---|---|---|
| | | | | | through reverse Venturi) |
| Relative humidity: | 80% | | [symbol] | 100% | |
| Temperature: | 80° | F. | | 80° | F. |
| Dew point: | 73.3° | F. | [symbol] | 80° | F. |

It is known in the art the following quantitative relationships:
Bernoulli's equation: P₁+½ ρv₁²+ρgy₁=O₂+½ ρv₂²+ρgy₂+h_{L}
Equation of continuity: ρ₁A₁v₁=ρ₂A₂v₂; ρ₁=ρ₂=>A₁v₁=A₂v₂
   which hold for substantially adiabatic and isentropic flows. Or, solving for one of the velocity variables,

v₁=√[2g(y₂−y₁+(P₂−P₁)/ρg+v₂²/2g+H_{L})]

Using the above two equations we can calculate the area of the expanded chamber A₂ by substituting the possible values for ρ=0.07272 lb/ft³, g=32.17 m/s², v₂=5 ft/sec, y₁=10 ft, y₂=1 ft, and H_{L}=6 ft (head loss).

In this example we get for v₁=130.24 ft/sec and A₁=1 ft², a value for A₂ of 26 ft², which are dimensions that can be practically fabricated. Other areas could be used to alter the flow rate, or affect a more substantial pressure rise.

Thus the invention consists of duct work that is incorporated in a gas capture device, and can be fabricated by bending, forming, casting, welding, riveting, etc., from metal, plastic, composite, or other materials as is known in the art. The adsorbent material might be comprised of NaOH, and a working fluid Na₂CO₃ as is commonly used in the art, although other reactants with CO₂ might be useable.

### BRIEF DESCRIPTION OF THE DRAWINGS

The invention is herein described, as through example only, with reference to the accompanying drawings, wherein:

FIG. 1 is a drawing providing an overview of the various units of which the System is comprised, and their relationship to one another, with respective inputs and outputs of each unit. Gas, for instance air, in the preferred embodiment, enters the system through the Gas Inlet 101, where also Nozzle Fluid Inlets 102 contribute Absorbent into the gas flow, which proceeds into the Inlet Reverse Venturi 103, which is an expanding conduit. Here the pressure rises, because the velocity of the gas slows, as per Bernoulli's equation. The area of the Inlet Reverse Venturi 103 and subsequent Gas Capture Chamber 106 has been calculated so that the pressure rise equals or exceeds the difference between the ambient pressure and the pressure necessary to attain the dew point of the gas. This has been engineered so that the area works for all the operating range of the system, which is just the maximum pressure required for the lowest humidity and highest operating ambient temperature.

Once in the Gas Capture Chamber 106, the gas and absorbent mixture pass over the Contactor Plates 105, which are part of the Gas Capture Device 104. Here the absorbent absorbs CO₂ in the air, in the preferred embodiment. As the absorbent drips from the Contactor Plates 105 onto the Absorbent Collection Surface 107, it is drained from the Gas Capture Chamber 106 into Outlet Conduit Lines, where it then proceeds to the External Absorbent Regeneration Unit, where the CO2 of the preferred embodiment is removed and passed out of the system, and the absorbent is thus regenerated, and passes again to the Nozzle Fluid Inlets 102.

Meanwhile, the gas, less the absorbed CO2, passes through the Offset Expansion Chamber 109 and then into the Outlet Venturi 110, and finally through the Gas Outlet 111 where it exits the system.

FIG. 2 shows that when a pressure drop is fabricated into an instance of the invention, it will be substantially maintained for other ambient temperatures, as the dew points for different pressures at a given temperature differ by a basically constant amount.

FIG. 3 compares a Venturi device with the Reverse Venturi device used in the invention, explaining the physical basis for the different performance.

What is claimed is:

1. A Gas Capture System comprising:
A Gas Inlet for continuously flowing gas input;
One or more Input Conduit Lines for feeding Absorbent into the system, consisting of one or more Nozzle Fluid Inlets to inject an Absorbent into said Gas Inlet;
One or more Output Conduit Lines for draining Absorbent from the system, where it passes to an Absorbent Regeneration Unit before returning through said Input Conduit Lines, in a continuous process;
An expanding Inlet Reverse Venturi device, connected to said Gas Inlet on one end and to a Gas Capture Chamber on the other, which results in the higher Operating Pressure within said Gas Capture Chamber;
Said Gas Capture Chamber surrounding and containing a Gas Capture Device, comprised of one or more Contactor Plates where said Absorbent flows along their outer surface for the purpose of collecting a specific gas from the passing gas flow;
An Absorbent Collection Surface below said Gas Capture Device to catch the Absorbent as it drips from the Contactor Plates, where it subsequently passes through said Output Conduit Lines;
An Offset Expansion Chamber that maintains the higher pressure that results from the expanding Inlet Reverse Venturi, well past said Absorbent Collection Surface to maintain the saturation pressure in the gas;
A contracting Outlet Venturi device, wherein the large end is connected to said Offset Expansion Chamber and the small end is a Gas Outlet, the latter with substantially the same area as the Gas Inlet;
Said Gas Capture System where the area of the Gas Inlet is proportioned to the large area of the Inlet Reverse Venturi device such that the pressure increase across the device raises the Dew Point of the passing gas substantially equal to or above the temperature of the incoming gas.

2. A system as described in claim 1 where said Gas Capture Device is comprised of a conveyor of solid adsorbent, which similarly exits and reenters via conduits so that the adsorbent may be regenerated.

3. A system as described in claim 1 where said Gas Capture Device is comprised of a substantially open chamber into which said adsorbent is injected in an atomized form, as through a atomizing nozzle, which similarly exits through Output Conduit Lines and reenters via Input Conduit Lines so that the adsorbent may be regenerated.

4. A method comprising:
A Gas Capture device that uses a reverse Venturi to increase the pressure on an incoming gas so that it equals or exceeds its dew point, by slowing the velocity of the gas through an expanding chamber, thus reducing the evaporation of a sorbent material and/or increases the amount of water vapor it can adsorb;
A contracting Venturi device that returns the pressure to the original, after a length of offset that allows the sorbent material to exit from the Gas Capture device in order to be regenerated without substantial loss of moisture through evaporation.
